(19) United States
(12) Patent Application Publication
(10) Pub. No.: US 2011/0283596 A1
(43) Pub. Date: Nov. 24, 2011

(54) Fishing Float Device for Ice Fishing

(76) Inventor: Ernst Robinson, Denver, CO (US)

(21) Appl. No.: 12/783,543

(22) Filed: May 19, 2010

(51) Int. Cl. A01K 93/00

(52) U.S. Cl. 43/44.92; 43/43.1; 43/44.87

(57) ABSTRACT

The invention is a fishing float device specifically to be used on a fish line as a fish bite indicator for ice fishing. The fishing float device provides a simple means of attachment and release allowing greater versatility fishing through ice. By design this system slides on gripping the fish line by utilizing friction versus fixed to the fish line allowing an angler to fish at any depth through ice and remove, or dislodge the fishing float with ease when desired.

### BACKGROUND OF THE INVENTION

The angler has known the art of the fishing float, as a bite indicator, since the first stick or cork was tied on a fish line. Those skilled in the art have defined the fishing float as two types in the present day. These types of floats are referred to as fixed-type and slip-type.

Fixed-type fishing floats use numerous techniques to attach the fishing float to the fish line. As it suggests, fixed-type floats are attached in a stationary position at a given location on the fish line, and determines the depth wished to be fished. Illustrated in Guy DeFrisco patent in 2002, (U.S. Pat. No. 6,467,214) the fish line is tethered to both ends of the fishing float. The float design consists of a buoyant body with a wire system that extends through the center of the float, formed at each end of the wire system are loops. One loop will be utilized to tether the float device to the main-line, the fish line coming from the rod and reel. The leader, the fish line attached to a hook and bait and/or a lure, is then tethered to the final loop of the float, opposite the main-line. Shane Wilson's patent in 1994, (U.S. Pat. No. 5,329,722) is another illustration of a fishing float device using a clamping apparatus to attach the float device to the fish line. The device is constructed of a buoyant body with a stem protruding from each end of the body. At one end, referenced as the bottom stem, a slot is constructed perpendicular to the stem to accept the fish line. A spring apparatus is connected to the end of the bottom stem allowing it to slide over top of the fish line clamping the fish line to the float. L. Schmidt's patent in 1962, (U.S. Pat No. 3,060,621) still to date is the most poplar fishing float on the market today. This float also functions with a spring apparatus to attach the fish line to the float. This fishing float has a buoyant body with at one end a set diameter bore large enough to accept a spring-button apparatus. The spring-button apparatus has a small bore to accept a wire/hook apparatus. At the opposite end of the buoyant body is a smaller bore with a set diameter through to the bore configured with the spring-button apparatus. Through the bores provided of the buoyant body and spring-button apparatus, the wire/hook apparatus is placed with the hooks at each end containing the spring-button within the buoyant body completing the float design. When the spring-button is engaged the wire/hook apparatus is exposed to tether to the fish line. The fixed-type design generally limits an angler to fish shallower depths securing the float to the fish line at a desired depth. Although fixed-type fishing floats are efficient for other styles of fishing, they become an obstruction on the fish line when fishing through ice, particularly at greater depths. It should be noted, the term fix and/or fix-to is used to define and/or describe a fishing float tethered and/or secured to a fish line and if detached would require some sort of time taxing manual operation, and/or breaking the fish line, to remove the float.

Slip-type fishing floats are also fixed-to the fish line, however they are able to travel along the fish line. The method of attachment for this type of fishing float is via a bore, or passage from end to end of the fishing float that allows the fish line to pass through. In combination with the slip-type fishing float, there generally is a float stop (rubber material, soft string) that is attached to the fish line above the float creating an obstruction. The float will travel along the fish line until butting against the float stop. The stop determines the depth at which the angler is fishing. In 1992, Glennis Lasitea's patent (U.S. Pat. No. 5,117,576) illustrates as described this type of float design. Sam Rayburn's patent in 1983, (U.S. Pat. No. 4,418,492) illustrates this type of fishing float, whereas the fish line is accepted through a slit of the float body and stem. Once the fish line is contained within the stem, the stem is rotated to secure the fish line to the float. At present, slip-type float systems are the preferred system to date, for the use as a bite indicator fishing through ice. The downfall to the slip-type float, when fishing through ice, is that it can become iced up, and/or debris can get lodged in the bore, thus disabling the fishing float to travel on the fish line. The worst-case scenario is that the float becomes lodged resulting in it breaking off.

Essentially both types of fishing floats are effective fish bite indicators for fishing non-ice fishing styles. The efficiency of these types of floats is hindered fishing through ice as a result of being fixed-to the fish line, and requiring time taxing manual detachment from the fish line. Both types of floats are subject to frequent problems particularly fishing greater depths through ice, ultimately resulting in a number of lost catches.

By design the present invention of fishing float device allows an angler to fish through ice efficiently, at all depths, by means of the system of attachment. The present invention utilizes a desired system of attachment, which can slide and/or clamp onto, gripping the fish line in a perpendicular manner, securing it at a desired depth utilizing friction. Thereby an angler can attach the fishing float at a set depth and change the depth with ease if desired. When the present invention is attached to the fish line and the angler experiences a fish biting he/she can set the hook to catch the fish. This action setting the hook will dislodge, and/or slip the present invention off the fish line, removing the fishing float allowing for a safe retrieval of the catch. This feature of the present invention sliding onto the fish line and the ability to dislodge off the fish line proves to be a substantial benefit from other types of fishing floats when fishing through ice.

### SUMMARY OF THE INVENTION

The present invention represents a fishing float device that provides an angler with a simple, yet inexpensive means, of a fish bite indicator, to fish through ice. To attain this, the apparatus utilizes friction to grip the fish line to provide a quick and effective method of attachment and release, and therefore greater versatility fishing at any depth through ice. The present invention is configured with a buoyant body with one and/or both ends of the body via adhering, molding, and/or tethered by a cord, the system of attachment, enabling the device to slide and/or clamp on and grip the fish line.

The buoyant body has a variety of shapes, including, but not limited to, spherical egg, tear, oval, round, cylindrical, and cone, and can vary in size. The materials used for the buoyant body, but not limited to, are wood, plastic, and foam that are suitable materials for shaping, with great buoyancy. Wood materials to be used, but not limited to, are balsa wood, basswood, paulownia wood, and cork oak bark, which have structural characteristics of being strong, lightweight, easy to shape, and excellent buoyancy. Plastic materials to be used, but not limited to, are polyvinyl chloride, acrylonitrile butadiene styrene, nylon, chlorinated polyvinyl chloride, and polyurethane that are easily molded into buoyant shapes, and are durable lightweight materials. Foam materials to be used, but not limited to, like polyethylene, polystyrene, expanded polystyrene, and ethylene vinyl acetate are easily molded into buoyant shapes, and are lightweight durable materials with excellent buoyancy characteristics. The buoyant body may vary in combination with shape, size, and material, to vary the buoyancy of the embodiment of the present invention for different styles of fishing, giving an angler greater versatility fishing through ice. At one and/or both ends of the buoyant body the system of attachment can be attached via adhering, molding, and/or tethered by a cord.

The system of attachment stays the same, relative to function, with change of size, shape, and material of the buoyant body. The system attachment is designed in four configurations to create a different gripping action on the fish line, for versatility and different styles of ice fishing. In one configuration, the system of attachment is constructed of a plastic material in a cylindrical form with a set diameter and length that houses a rubber-type apparatus at one end. At one end of the cylindrical apparatus a bore is constructed perpendicular with a set diameter, to allow the apparatus to be tethered by a cord, to a buoyant body. At the opposite end and parallel to, the cylindrical apparatus has a bore constructed with a set diameter and depth. Also at this end, the cylindrical apparatus has two slots formed, parallel, and opposite sides of, with set width and length to accept a fish line. Plastic materials to be used, but not limited to, are acrylonitrile butadiene styrene, polyvinyl chloride, nylon, chlorinated polyvinyl chloride, polypropylene, and acrylic, that are easily molded into shapes, and are durable lightweight materials to construct this cylindrical apparatus. The rubber-type apparatus is designed in a shape, to fit the center diameter of the cylindrical apparatus and be adhered to. The cylindrical apparatus will create compression on the rubber-type apparatus. It is the compression created on the rubber-type apparatus that creates the friction unitized in the function of the system of attachment. A slit through the center of the rubber-type apparatus is constructed to a set depth to accept a fish line. The rubber-type apparatus will be constructed of materials having high elasticity characteristics such as latex, silicone, neoprene, butyl, and rubber. When constructed, the slots of the cylindrical apparatus will be fitted parallel to the slit of the rubber-type apparatus, creating the system of attachment. This enables the system of attachment to accept and grip the fish line. This apparatus is then adhered, molded, and/or tethered by a cord, to the buoyant body at one, and/or both ends creating the present invention.

In the second configuration, the system of attachment is constructed of a spring material in a u-shape forming two legs. The legs are coated with a protective coating, and are compressed together creating a slit in the apparatus to accept a fish line Where the apparatus is bent forming two legs, a loop is formed. This loop will be utilized to tether the apparatus to buoyant body via a cord. Spring type materials used for this u-shaped apparatus, include, but are not limited to, are spring steels and/or plastics. Spring steels to be used, include, but are not limited to, be stainless steel, and high carbon steel. Plastic materials to be used, include, but are not limited to, are polyvinyl chloride, chlorinated polyvinyl chloride, acrylonitrile butadiene styrene, nylon, polyurethane that are easily molded into shapes, and are durable. Protective coatings used, include, but are not limited to, are vinyl, latex, silicone, Teflon, neoprene, nitrole. Flat and/or round wire forms will be utilized to create different gripping actions on the fish line as well as durability. The spring formed apparatus can be adhered, molded, and/or tethered via a cord to a buoyant body.

In the third configuration, the system of attachment again utilizes the spring material formed in a u-shape creating two legs. As discussed in the text above, the legs are coated with a protective coating, and are compressed together creating a slit in the apparatus to accept a fish line. Where the apparatus is bent forming two legs, a loop is formed. This loop will be utilized to tether the apparatus to buoyant body via a cord. The spring formed apparatus is configured within a push-button system, whereas when engaged the legs extend out of a plastic housing, and spread apart to accept a fish line. When the push/button system is disengaged, the u-shape spring apparatus will clamp on and grip the fish line utilizing friction. This system can be tethered via a cord, molded, adhered, and/or formed to a buoyant body.

For the forth configuration, the system of attachment is a molded embodiment. The apparatus consist of a base configuration suitable to be attached to different buoyant body styles, via adhering, molding, and/or tethering with a cord. Three posts with a cylindrical shape are configured in a three-point configuration and perpendicular from the base. The perpendicular edge of each post touches the other at three points. Where these three posts touch, slits are formed to accept a fish line. The slits create compression, which creates the friction utilized to grip a fish line. Elastic materials to utilize in molding this apparatus, include, but are not limited to, are latex, silicon, neoprene, butyl, and rubber.

Each of these systems of attachments, are capable of being constructed independently or universally, with different configurations, to attach to any style of fish float. This will be accomplished by using a cord to tether to a float, a cylindrical housing to mount on a stem float, and/or a ring to clamp on spring style float or use on a loop style float. Other attachment styles may be used as well.

Each of the four systems of attachment are constructed independently of a buoyant body as well. This allows the apparatus to be used with any fish float on the market as well as being manufactured as a fishing float system.

The color of the present invention is important to accommodate the different lighting conditions of the day, when used as a fish bite indicator, fishing through ice. The float colors will be visible through ice, on ice, snow, and different lighting conditions of the day. The present invention will utilize single colors, and/or multiple colors, to optimize versatility for all lighting conditions.

As described in the earlier text, the present invention slides and/or clamps onto the fish line in a perpendicular manner securing it at a desired depth utilizes friction and is not fixed to the fish line. It should be reiterated that the ability of this present invention to dislodge from the fish line, at any depth an angler is fishing, gives it an unmatched versatility, as a fish bite indicator for ice fishing.

### BRIEF DESCRIPTION OF THE DRAWING

FIG. 6 is a perspective view of the components that comprise the second system of attachment.

FIG. 7 illustrates a perspective view of the fishing float embodiment with a mushroom shape buoyant body, with the second system of attachment at one end gripping a fish line.

FIG. 8 illustrates a perspective view of the fishing float embodiment with a teardrop shape buoyant body that includes a stem, with the second system of attachment at the end gripping a fish line.

FIG. 9 illustrates a perspective view of the fishing float embodiment with a cone shape buoyant body, with the second system of attachment at both ends gripping a fish line at the bottom.

FIG. 10 illustrates a perspective view of the fishing float embodiment with a cylindrical shape buoyant body that includes a stem, with the second system of attachment attached to the stem and gripping a fish line at the bottom.

FIG. 11 illustrates a perspective view of the fishing float embodiment with a egg shape buoyant body, with the second system of attachment tethered to a cord at the top and gripping a fish line at the other, the other end of the cord attached to the buoyant body.

### DETAILED DESCRIPTION OF THE INVENTION

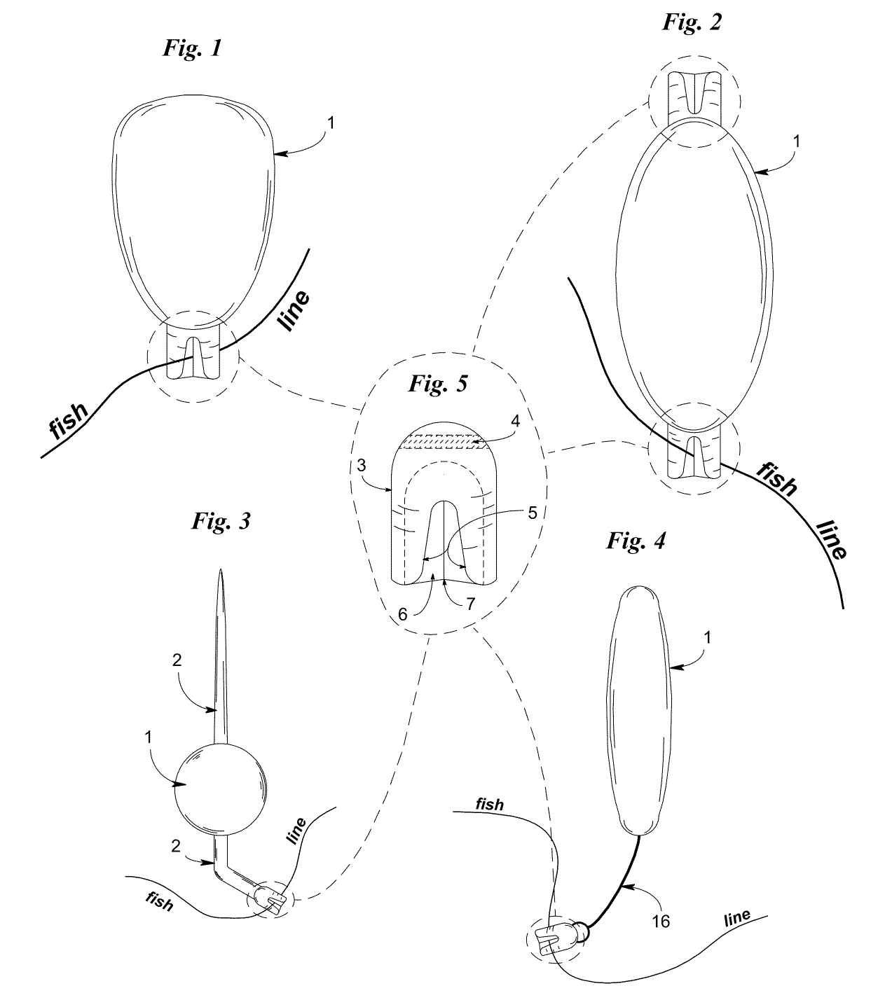

The present invention is a fishing float device specifically designed to use on a fish line, as a fish bite indicator, through ice. The drawings will illustrate and depict an improved system of attachment for a fishing float to fish through ice. FIG. 6 depicts a system of attachment that is illustrated in a number of configurations of buoyant bodies designated as the numeral 1.

The system of attachment FIG. 6 is shown; a spring-form 8 is conformed in a u-shape creating two legs 11. Where the spring-form 8 is a conforming u-shape a loop 12 is constructed to accept a cord 16 to tether to a buoyant body 1. A retainer ring 9 is attached near the loop 12 section of the spring-form 8. The spring-form 8 conforms a slit 7 to accept a fish line; a protective coating 10 is adhered to both legs. The protective coating 10 protects the fish line from damage in the act of catching a fish.

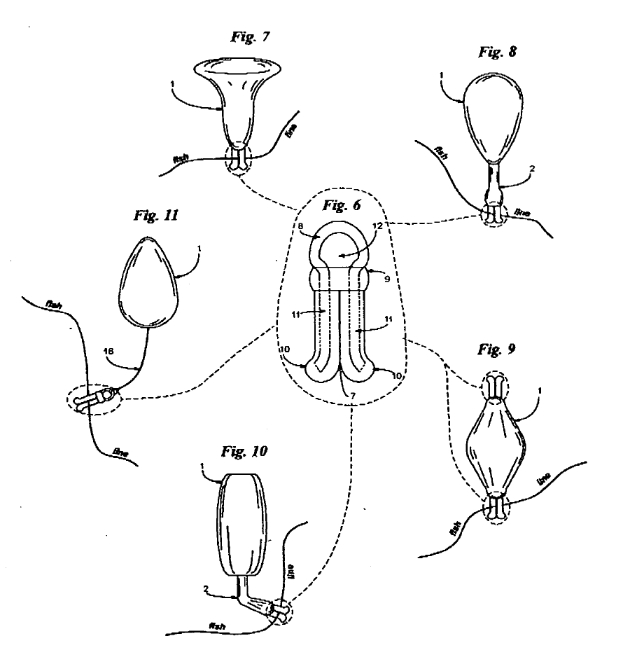

FIG. 7 illustrates a mushroom shape buoyant body 1 comprising the system of attachment FIG. 6 at the bottom, gripping a fish line.

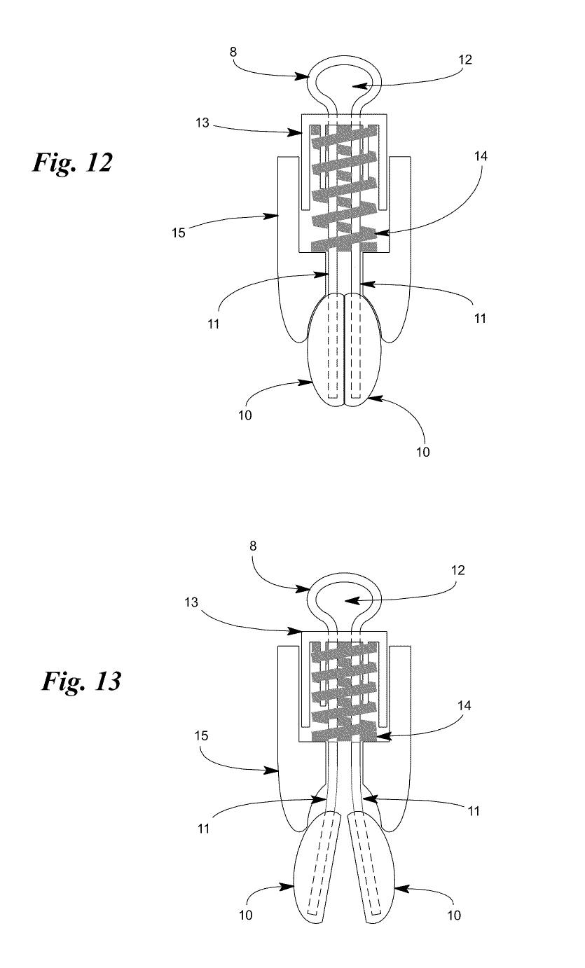

FIG. 8 illustrates a teardrop buoyant body 1; a stem 2 extends from the bottom of the buoyant body 1. At the bottom of the stem 2 the system of attachment FIG. 6 is attached, and gripping a fish line.

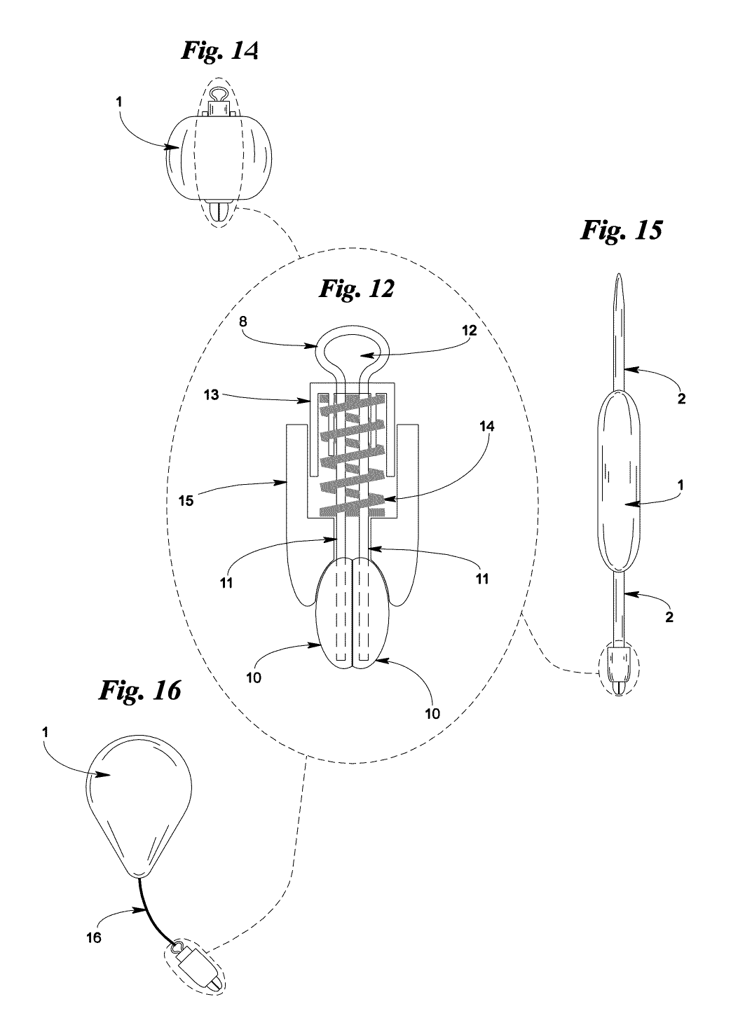

FIG. 9 illustrates cone shaped buoyant body 1, configured with the system of attachment FIG. 6 at top and bottom, the bottom gripping a fish line.

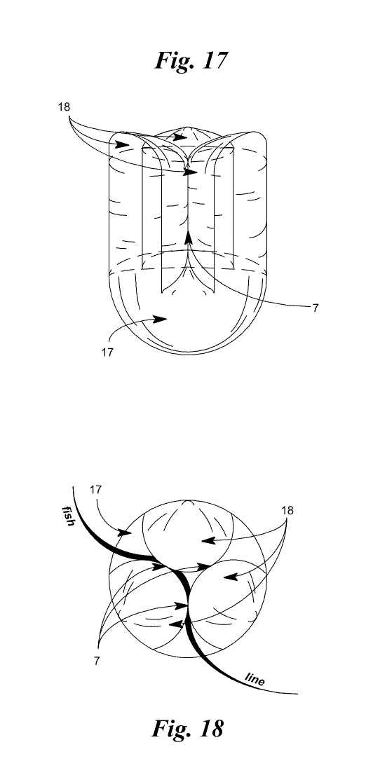

FIG. 10 illustrates an elongated oval buoyant body 1; a stem 2 extends from the bottom of the buoyant body 1. Attached at the bottom of the stem 2 is the system of attachment FIG. 6, and gripping a fish line.

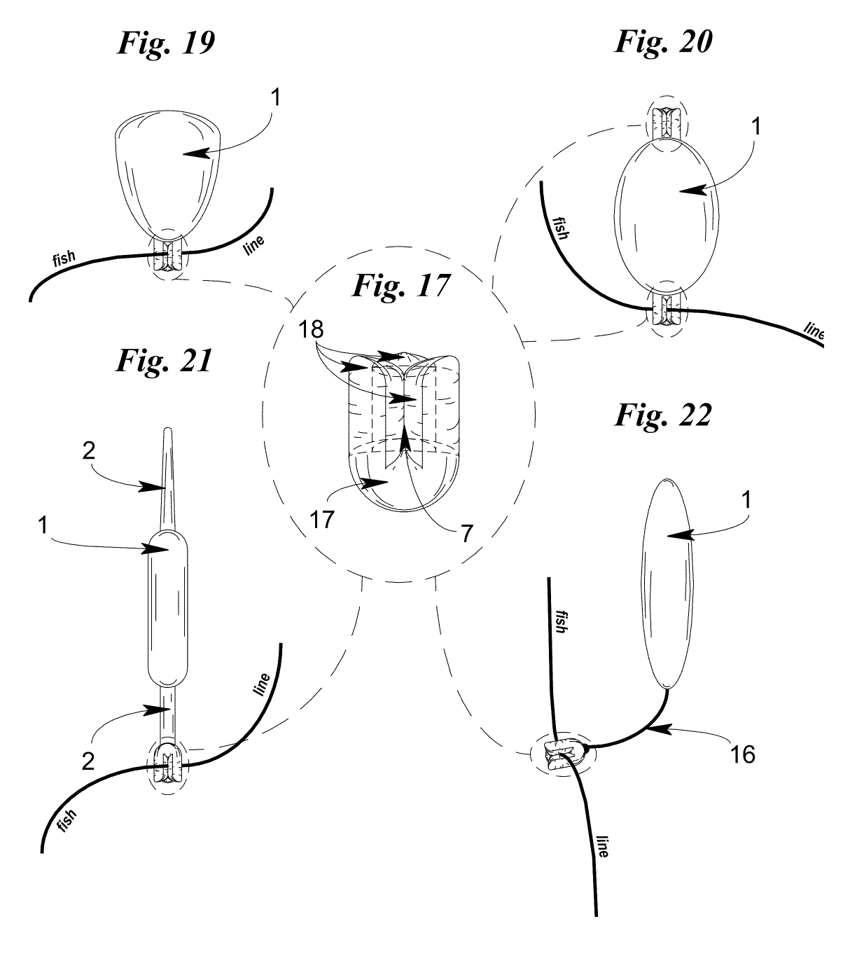

FIG. 11 the present invention configured with an egg shape buoyant body 1. Attached at the bottom of the buoyant body 1 is a cord 16. Tethered at the opposite end of the cord 16 is the system of attachment FIG. 6, and is gripping a fish line.

While the present invention has been illustrated by the descriptions of the embodiments thereof, and while the embodiments have been described in detail, it is not intended to restrict or in any way limit the scope of the appended claims to such detail. It is therefore to be understood that, within the scope of the appended claims, the invention may be practiced otherwise to those skilled in the art, without departing from the principles and concepts of the invention.

1. A fishing float device comprising:
a system of attachment configured at one end of a buoyant body, to be utilized as a fish bite indicator ice fishing at any depth;
a system of attachment, as described in the text and illustrated in the drawings, that will slip, slide, and/or clamp onto a fish line in a perpendicular manner utilizing friction to grip the fish line;
a system of attachment with the ability to dislodge from the fish line, when an ice angler sets the hook, in the act of a fish bite.

2. A fishing float device comprising:
a system of attachment configured at both top and bottom of a buoyant body, to be utilized as a fish bite indicator ice fishing at any depth;
a system of attachment, as described in the text and illustrated in the drawings, that will slip, slide, and/or clamp onto a fish line in a perpendicular manner utilizing friction to grip the fish line;
a system of attachment with the ability to dislodge from the fish line, when an ice angler sets the hook, in the act of a fish bite.

3. A fishing float device comprising:
a system of attachment tethered to a cord at the loop designed into the system of attachment and attach to a buoyant body at one and/or multiple ends, to be utilized as a fish bite indicator ice fishing at any depth;
a system of attachment, as described in the text and illustrated in the drawings, that will slip, slide, and/or clamp onto a fish line in a perpendicular manner utilizing friction to grip the fish line;
a system of attachment with the ability to dislodge from the fish line, when an ice angler sets the hook, in the act of a fish bite.

4. A fishing float device comprising:
a system of attachment configured to the end of a system and/or multiple stems, the opposite end of the stem and/or stems then configured to a buoyant body at one and/or multiple ends, the system together utilized as a fish bite indicator ice fishing at any depth;
a system of attachment, as described in the text and illustrated in the drawings, that will slip, slide, and/or clamp onto a fish line in a perpendicular manner utilizing friction to grip the fish line;
a system of attachment with the ability to dislodge from the fish line, when an ice angler sets the hook, in the act of a fish bite.

5. A fishing float device comprising:
a system of attachment configured to the end of a stem and/or multiple stems with a bend, the opposite end of the stem and/or stems then configured to a buoyant body at one and/or multiple ends, the system together to be utilized as a fish bite indicator ice fishing at any depth;
a system of attachment, as described in the text and illustrated in the drawings, that will slip, slide, and/or clamp onto a fish line in a perpendicular manner utilizing friction to grip the fish line;
a system of attachment with the ability to dislodge from the fish line, when an ice angler sets the hook, in the act of a fish bite.

6. A system of attachment utilizing, as described in the text and illustrated in the drawings, friction to grip a fish line.

7. A system of attachment utilizing spring steel and plastic materials to create, as described in the text and illustrated in the drawings, the preferred embodiment to grip a fish line.

8. A system of attachment configured with only:
a cord tethered at the loop designed into the system of attachment and at the opposite end of the cord a loop configured to attach and/or detach as well as reuse the embodiment with a variety of fish floats;
a stem attached loop designed into the system of attachment to attach and/or detach as well as reuse the embodiment with a variety of fish floats;

9. A fishing float device according to claims 1, 2, 3, 4, and 5, wherein said the buoyant body can vary in materials and combination of materials used in constructing the preferred embodiment for different styles of fishing through ice.

10. A fishing float device according to claims 1,2,3,4, and 5, wherein said vary in size for different styles of fishing through ice.

11. A fishing float device according to claims 1, 2, 3, 4, and 5, wherein said the buoyant body vary in shape for different styles of fishing through ice.

12. A fishing float device according to claims 1, 2, 3, 4, and 5, wherein said vary in color and/or colors to accommodate different lighting conditions of the day for fishing through ice.
